(19) United States
(12) Patent Application Publication
(10) Pub. No.: US 2005/0250500 A1
(43) Pub. Date: Nov. 10, 2005

(54) Communication method, packet radio system, controller and user terminal

(76) Inventor: Zhaoji Xu, Beijing (CN)

Correspondence Address: SQUIRE, SANDERS & DEMPSEY L.L.P., 14TH FLOOR, 8000 TOWERS CRESCENT, TYSONS CORNER, VA, 22182, US

(21) Appl. No.: 10/910,546

(22) Filed: Aug. 3, 2004

(30) Foreign Application Priority Data
May 7, 2004 (FI) 20040652

(51) Int. Cl. H04Q 7/20

(52) U.S. Cl. 455/442

(57) ABSTRACT

A communication method, a packet radio system, a controller and a user terminal. The packet radio system includes a controller, a user terminal and more than one base stations communicating with the controller and a user terminal of the packet radio system. A processing unit of the controller is further configured to define a subset of an active set of soft handover on the basis of performances of base stations in the active set, and to provide information on which base stations are included in the defined subset, and the processing unit of the user terminal is further configured to monitor HARQ information only from the base stations that are included in the defined subset.

### BACKGROUND OF THE INVENTION

1. Field of the invention

The invention relates to a communication method in a packet radio system, to a packet radio system, to a controller for a packet radio system and to a user terminal for a packet radio system.

2. Description of the Related Art

There are different approaches to HARQ (Hybrid Automatic Repeat reQuest) in soft handover situations. In one possible scheme, each Node B in an active set of soft handover receives data from a user terminal and transmits ACK/NACK (positive acknowledgement/negative acknowledgement) down to the user terminal. If the user terminal receives no ACK from any Node B in the active set of soft handover, retransmission occurs. If at least one ACK is received, new data is transmitted instead. With macro diversity gain and chase combining, this scheme has provided good performance when ACK/NACK signalling is free of errors.

Soft handover decisions are based on measurements of a DL CPICH (down link common pilot channel) channel. Since the quality of the uplinks between a user terminal and different Node Bs is not checked, in soft handover the quality cannot be guaranteed. In Release '99, for example, more Node Bs in the active set always mean more soft handover gains, regardless of the individual gains of each Node B. In enhanced uplink packet access (EUPA), when HARQ is used, the more Node Bs, the more signalling and also probable signalling errors. EUPA introduces enhancements in the uplink like L1-ARQ (physical layer automatic repeat request) and Node-B scheduling for increased throughput and reduced delays. Signalling errors (e.g. NACK understood as ACK) lead to adverse effects in HARQ operations.

In the downlink direction, ACK/NACK signalling does not benefit from soft handover gain, which means an increased error possibility especially for the worse links of the set. The influence of such errors in ACK/NACK understanding can be very harmful. For instance, if all the Node Bs transmit NACK and one of the NACKs is decoded by the user terminal as ACK, new data is transmitted and thus RLC (radio link control) ARQ retransmission occurs. Further, delay gain of L1-HARQ is lost. Conversely, if all the ACKs are received as NACK, unnecessary retransmission happens and the delay increases. In the uplink direction, errors in uplink signalling may result in unsynchronized HARQ processed in different Node Bs.

The existence of Node Bs with poor uplink performance (uplink unbalance) in a soft handover active set brings no valuable soft handover gain. Further, the HARQ signalling error of these Node Bs with poor uplink performance may still lead to harmful results. Thus, more Node Bs in the active set does not always mean improved performance when HARQ is used in EUPA.

Regarding the ACK/NACK understanding error, different attempts have been made to overcome the problem. One attempt is to increase the energy of ACK/NACK. However, user terminals may not have enough Rake fingers for all the Node Bs, so even the increased energy on ACK/NACK cannot guarantee that all the ACK/NACKs are received correctly. Another solution is to decode ACK/NACK only from Node Bs that are strong enough (by downlink signal strength). However, the uplink macro diversity gain can be lost when one Node B has a good uplink connection but a poor downlink signal strength. Another alternative solution is that each Node B would send ACK/NACK first to a radio network controller (RNC) and then the RNC generates a combined result of the ACK/NACK and sends it back to each Node B. As a result, the user terminal would be able to combine all the ACK/NACK from Node Bs. However, this operation requires some additional delay from RNC to Node B, which is against the aims of HARQ.

### SUMMARY OF THE INVENTION

According to an aspect of the invention, there is provided a communication method in a packet radio system using a Hybrid Automatic Repeat reQuest (HARQ), the method comprising defining, by a controller, a subset of an active set of soft handover on the basis of performances of base stations in the active set, providing information on which base stations are included in the defined subset, and monitoring, by a user terminal, HARQ information received only from the base stations that are included in the defined subset.

According to an embodiment of the invention, there is provided a packet radio system using a Hybrid Automatic Repeat reQuest (HARQ), the packet radio system comprising a controller configured to control radio resources of the packet radio system, the controller including a transceiver for communicating with a user terminal and one or more base stations of the packet radio system, and a processing unit for controlling the functions of the controller, a user terminal including a transceiver for communicating with the controller and one or more base stations of the packet radio system and a processing unit for controlling functions of the user terminal, and more than one base stations communicating with a controller and a user terminal of the packet radio system. The processing unit of the controller is further configured to define a subset of an active set of soft handover on the basis of performance of base stations in the active set, and to provide information on which base stations are included in the defined subset, and the processing unit of the user terminal is further configured to monitor HARQ information received only from the base stations that are included in the defined subset.

According to an embodiment of the invention, there is provided a controller for a packet radio system using a Hybrid Automatic Repeat reQuest (HARQ), the controller comprising a transceiver for communicating with one or more base stations and user terminals of the packet radio system, and a processing unit for controlling functions of the controller. The processing unit of the controller is further configured to define a subset of an active set of soft handover on the basis of performances of base stations in the active set, and to provide information on which base stations are included in the defined subset for enabling a user terminal to monitor HARQ information received only from the base stations that are included in the defined subset.

According to an embodiment of the invention, there is provided a user terminal for a packet radio system using a Hybrid Automatic Repeat reQuest (HARQ), the user terminal comprising a transceiver for communicating with a controller and one or more base stations of the packet radio system, and a processing unit for controlling functions of the user terminal. The processing unit is further configured to monitor HARQ information received only from the base stations that are included in a subset defined by the controller on the basis of performances of base stations in an active set of soft handover.

According to an embodiment of the invention, there is provided a packet radio system using a Hybrid Automatic Repeat reQuest (HARQ), the packet radio system comprising a controller for controlling one or more base stations of the packet radio system, the controller including communication means for communicating with a user terminal and one or more base stations of the packet radio system, a user terminal including communication means for communicating with the controller and base stations of the packet radio system, and more than one base stations including communication means for communicating with a controller and a user terminal of the packet radio system. The controller further comprises defining means for defining a subset of the active set of soft handover on the basis of performances of base stations in the active set, and indication means for providing information on which base stations are included in the defined subset, and the user terminal further comprises monitoring means for monitoring HARQ information received only from the base stations that are included in the defined subset.

According to an embodiment of the invention, there is provided a controller for a packet radio system using a Hybrid Automatic Repeat reQuest (HARQ), the controller comprising communication means for communicating with one or more base stations and user terminals of the packet radio system, and controlling means for controlling functions of the controller. The controlling means further comprise defining means for defining a subset of an active set of soft hand over on the basis of performances of base stations in the active set, and indicating means for providing information on which base stations are included in the defined subset for enabling the user terminal to monitor HARQ information received only from the base stations that are included in the defined subset.

According to an embodiment of the invention, there is provided a user terminal for a packet radio system using a Hybrid Automatic Repeat reQuest (HARQ), the user terminal comprising communication means for communicating with a controller and more than one base stations of the packet radio system, and controlling means for controlling functions of the user terminal. The controlling means are further configured to monitor HARQ information received only from the base stations that are included in a subset defined by the controller on the basis of performances of base stations in an active set of soft handover.

The embodiments of the invention provide several advantages. Traffic load in the packet radio system is reduced without losing the major soft handover gain at the same time.

### BRIEF DESCRIPTION OF THE DRAWINGS

In the following, the invention will be described in greater detail with reference to preferred embodiments and the accompanying drawings, in which

FIG. 1 shows an example of a packet radio system;

FIG. 2 illustrates another example of a packet radio system;

FIG. 3 illustrates an example of a communication method in a packet radio system; and

FIG. 4 illustrates another example of a communication method in a packet radio system.

### DETAILED DESCRIPTION OF PREFERRED EMBODIMENTS

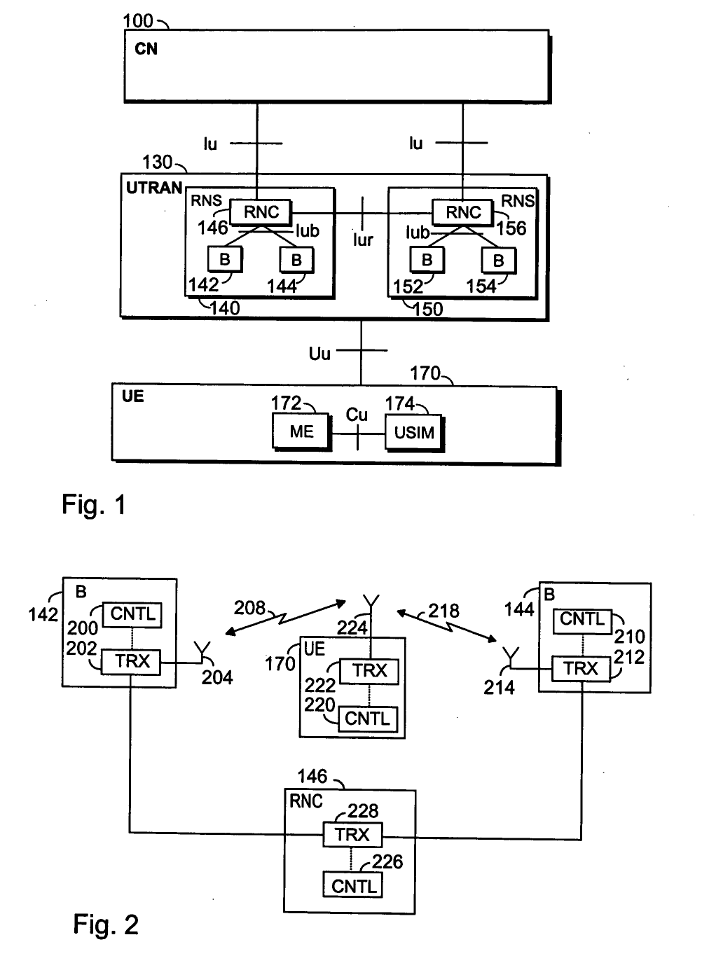

With reference to FIG. 1, let us examine an example of a packet radio system to which the preferred embodiments of the invention can be applied. A packet radio system in FIG. 1, known at least as UMTS (Universal Mobile Telecommunications System) and IMT-2000 (International Mobile Telecommunications 2000), represents third-generation radio systems. The embodiments are not, however, restricted to these systems described by way of example, but a person skilled in the art can also apply the instructions to other radio systems containing corresponding characteristics.

FIG. 1 is a simplified block diagram, which shows the most important parts of a packet radio system and the interfaces between them at net-work-element level. The structure and functions of the network elements are not described in detail, because they are generally known.

The main parts of a packet radio system are a core network (CN) 100, a radio access network 130 and a user terminal (UE) 170. The term UTRAN is short for UMTS Terrestrial Radio Access Network, i.e. the radio access net-work 130 belongs to the third generation and is implemented by wideband code division multiple access (WCDMA) technology. The main elements of the UTRAN are a radio network controller (RNC) 146, 156, Node Bs 142, 144, 152, 154 and user terminal 170. The UTRAN is attached to the existing GSM core network 100 via an interface called lu. This interface is supported by the RNC 146, 156, which manages a set of base stations called Node Bs 142, 144, 152, 154 through interfaces called lub. The UTRAN is largely autonomous from the core network 100 since the RNCs 146, 156 are interconnected by an lur inter-face.

From the point of view of Node B 142, 144, 152, 154, i.e. a base station, there is one controlling RNC 146, 156, where its lub interface terminates. The controlling RNC 146, 156 also takes care of admission control for new mobiles or services attempting to use the Node B 142, 144, 152, 154. The controlling RNC 146, 156 and its Node Bs 142, 144, 152, 154 form an RNS (Radio Network Subsystem) 140, 150.

The user terminal 170 may comprise mobile equipment (ME) 172 and a UMTS subscriber identity module (USIM) 174. USIM 174 contains information related to the user and information related to information security in particular, for instance, an encryption algorithm. In UMTS networks, the user terminal 170 can be simultaneously connected to a plurality of Node Bs when soft handover occurs.

From the point of view of the user terminal 170, there is one serving RNC 146, 156 that terminates the link layer communications of the mobiles. From the point of view of the core network 100, the Serving RNC 146, 156 terminates the lu for this user terminal 170. The Serving RNC 146, 156 also exerts admission control for new mobiles or services attempting to use the core network 100 over its lu interface. Admission control ensures that mobiles are only allocated radio resources (bandwidth and signal/noise ratio) available in the network.

In UMTS, the most important interfaces between network elements are an lu interface between the core network 100 and the radio access net-work 130, and a Uu interface between the radio access network and a user terminal.

In the following, a packet radio system will be described by means of FIG. 2. FIG. 2 shows a part of a simplified packet radio system that comprises a user terminal 170, two base stations 142, 144 and a radio network controller 146. The first base station 142 comprises a transceiver 202, an antenna 204 and a processing unit 200. Likewise, the second base station 144 comprises a transceiver 212, an antenna 214 and a processing unit 210. The radio network controller 146 also comprises a transceiver 228 and a processing unit 226. The user terminal 170 comprises a transceiver 222 and an antenna 224 for establishing a radio connection, and a processing unit 220.

In the existing radio systems, wireless telecommunications connections are established by a user terminal and base stations which communicate with one another on a radio connection, i.e. calls or data transmission connections between different user terminals are established via base stations. This is illustrated in FIG. 2 by radio connections 208, 218.

The processing units 200, 210, 220, 226 refer to blocks controlling functions of the device and are nowadays usually implemented as a processor and its software, but various hardware solutions are also feasible, e.g. a circuit built from logic components or one or more application-specific integrated circuits, ASICs. A hybrid of these different implementations is also feasible.

The user terminal 170 may periodically send Channel Quality Indicator (CQI) reports to Node B 142, 144 for indicating the currently supported data rate at a predetermined packet error threshold. A CQI report indicates coding and modulation schemes and the number of multicodes a user terminal can support under current radio conditions. The user terminal 170 monitors HARQ information, including ACK/NACK, from Node B 142, 144. Further, the user terminal 170 also sends an acknowledgement (ACK/NACK) message for each packet for informing when to initiate retransmissions. With channel quality measurements available for each user terminal in a cell, a packet scheduler of Node B may optimize the scheduling among the users.

In an embodiment, the processing unit 226 of the radio network controller 146 is configured to define a subset of an active set of soft handover on the basis of the performances of all the Node Bs in the active set, and to provide information on which Node Bs 142, 144 are included in the defined subset. The processing unit 220 of the user terminal 170 is then configured to monitor HARQ information only from the Node Bs 142, 144 that are included in the defined subset.

Thus, the user terminal 170 monitors the HARQ process, including ACK/NACK, only of the Node Bs in the defined subset, rather than that of the whole active set.

The subset may normally be defined to include one or more Node Bs 142, 144 from the active set, for example. However, such is also possible, that the subset is defined not to include any Node Bs 142, 144 from the active set. If the subset is defined not to include any Node Bs 142, 144, the HARQ process may be off during soft handover in those situations.

In an embodiment, the radio network controller 146 is configured to decide which Node Bs 142, 144 should be in the subset. In an embodiment, radio network controller 146 picks Node Bs 142, 144 having good uplink performance to be included in the subset on the basis of uplink measurement reports received from Node Bs 142, 144. Thus, the major soft handover gain can be achieved with this subset and the user terminal needs to listen fewer ACK/NACKs, which is favourable.

In an embodiment, the radio network controller 146 is configured to define the subset on the basis of measurements of downlink performances. The radio network controller 146 may receive measurements reports, such as CQI information, from the user terminal 170. In another embodiment, both uplink and downlink performance measurements are used when defining the subset.

The Node Bs 142, 144 included in the subset may have normal HARQ processes, and the user terminal 170 receives and monitors the HARQ information sent by the Node Bs 142, 144 in the subset. On the other hand, the Node-Bs 142, 144 in an active set of soft handover but outside the subset may still decode uplink data and send it to the radio network controller 146 as before. Regarding their ACK/NACK operation, different alternatives can be selected. In an embodiment, the Node Bs 142, 144 outside the subset still send ACK/NACK to the user terminal 170 but the user terminal 170 does not decode them. In another embodiment, the Node Bs 142, 144 outside the subset may stop sending HARQ information, including ACK/NACK. The latter alternative is possible because the decision of the subset needs to be forwarded to the user terminal 170 by Node Bs 142, 144 and thus, each Node B 142, 144 may also know whether or not it is included in the subset. The latter alternative means reduction of unnecessary interference to the radio system.

In an embodiment, for each update of an active set, the radio network controller 146 is configured to check whether new Node Bs in the active set should be in the subset. The radio network controller 146 may send the update check result with a soft handover active set update command, for example. Regarding the update of the subset, similarly to the update of an active set, this update can also be event-triggered.

The radio network controller 146 is configured to use given algorithms and thresholds to make the necessary decisions when defining the subset on the basis of uplink and/or downlink measurements reports. The measurement reports may include signal to noise ratios (EbNo) or other thresholds, for example. In an embodiment, if a measured signal to noise ratio of one Node B is lower than the signal to noise ratio of the strongest Node B by a predetermined amount, this Node B is not included in the subset. For example, if the measured signal to noise ratio of a first Node B 142 is 3 dB lower than the signal to noise ratio of the strongest Node B 144, then the first Node B 142 is not included in the subset. The reason for that is that a weak Node B contributes a little, and the user terminal 170 has only a little chance to follow such a Node B's HARQ information.

In an embodiment, the radio network controller 146 is configured to add at least one additional subset update command. This command informs the user terminal 170 about which Node Bs 142, 144 in the active set should be in the subset. The update of a subset may be event-triggered. A trigger source can be a new radio network controller 146 decision on a subset, for example.

Regarding the setup and update of the soft handover active set, two alternative ways may be selected. In one embodiment, at least one more bit is added to the current soft handover active setup command and to the soft handover active set update command for indicating whether a new Node B 142, 144 should be in the subset. In another embodiment, the subset update command is sent directly after the active set setup command or the update command.

In an embodiment, Node Bs 142, 144 outside the subset may stop sending HARQ information. Node Bs 142, 144 can use discontinuous transmission (DTX) to stop sending the HARQ information. Thus, there is no need to provide information about the Node Bs 142, 144 included in the subset to the user terminal 170, and in an embodiment only the Node Bs 142, 144 are provided with the information on which Node Bs 142, 144 are included in the defined subset.

In an embodiment, user terminal 170 follows the subset commands to decide which ACK/NACK to listen to, for example. In an embodiment, the Node Bs 142, 144 in the subset may increase ACK/NACK energy for better performance. This possible because the minor and unnecessary Node Bs 142, 144 are not included and thus a fewer number of ACK/NACKs have to be received by the user terminal 170.

Such is also possible that all the Node Bs 142, 144 in the active set are defined to be included in the subset. Thus, the user terminal 170 monitors all the Node Bs in the active set because all the Node Bs are also included in the subset. In an embodiment, only a primary Node B 142, 144 is included in the subset. Thus, only the HARQ information of the primary Node B 142, 144 is monitored by the user terminal 170.

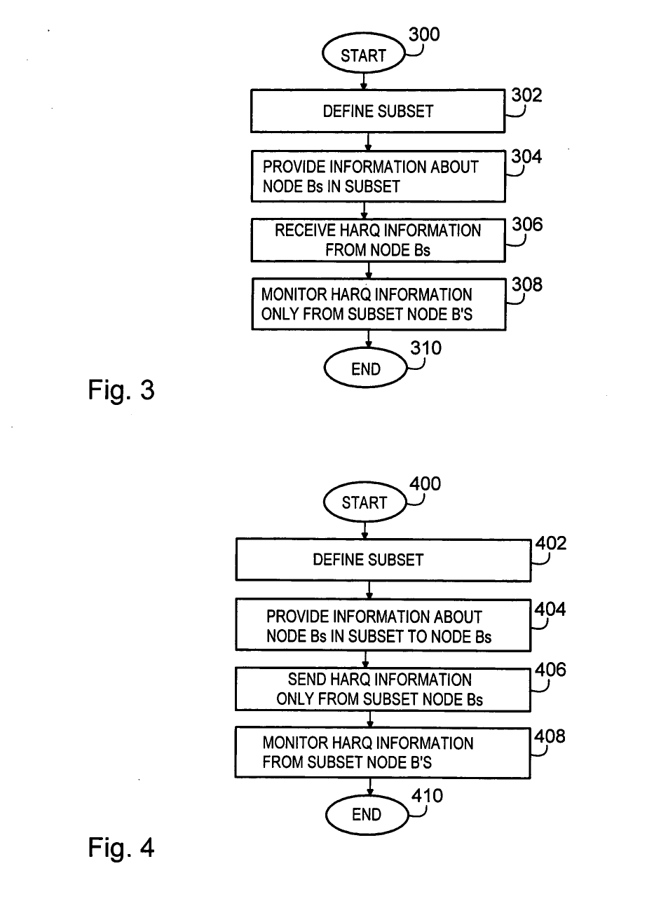

FIG. 3 shows an embodiment of a communication method in a packet radio system using a Hybrid Automatic Repeat reQuest (HARQ). The method starts in 300. In 302, a subset is defined of an active set of soft handover on the basis of the performances of all the base stations in the active set. The step of defining the subset may be based on uplink and/or downlink measurement reports or uplink performance levels of the base stations in the active set. In 304, information about which base stations are included in the defined subset is provided to the user terminal. In 306, the user terminal receives HARQ information from the base stations, and in 308, the HARQ information is monitored only from the base stations that are included in the defined subset. Thus, the user terminal may still receive HARQ information from all the base stations in the active set but does not decode the HARQ information from the base stations outside the subset, for example. The method ends in 310.

FIG. 4 shows another embodiment of a communication method in a packet radio system. The method starts in 400. In 402, a subset is defined to include, for example, one or more base stations from an active set of soft hand over on the basis of the performances of all the base stations in the active set. The step of defining the subset may be based on uplink and/or downlink measurement reports or uplink performance levels of the base stations in the active set. In 404, information about which base stations are included in the defined subset is provided to the user terminal. As the information about which base stations are included in the subset is sent to the user terminal via the base stations, the base stations may also have the information whether or not they are included in the subset. In 406, the user terminal receives HARQ information only from the base stations that are included in the subset. The base stations outside the subset may have stopped sending their HARQ information to the user terminal, for example. It is possible that in 404 the information about which base stations are included in the defined subset is no provided to the user terminal at all. Then only the base stations included in the subset send HARQ information to the user terminal, for example. Thus, in 408, the HARQ information is monitored only from the base stations that are included in the defined subset. The method ends in 410.

Even though the invention has been described above with reference to an example according to the accompanying drawings, it is clear that the invention is not restricted thereto but it can be modified in several ways within the scope of the appended claims.

1. A communication method in a packet radio system using a Hybrid Automatic Repeat reQuest (HARQ), the method comprising:
defining, by a controller, a subset of an active set of soft handover based on performances of base stations in the active set;
providing information on which base stations are included in the subset; and
monitoring, by a user terminal, HARQ information received only from base stations that are included in the subset.

2. The method of claim 1, wherein the step of defining the subset is further based on at least one of uplink and downlink measurement reports.

3. The method of claim 2, wherein the step of defining the subset is further based on uplink performance levels of the base stations in the active set.

4. The method of claim 2, wherein the step of defining comprises defining the subset based on the least one of the uplink and downlink measurement reports including channel quality indicator (CQI) reports.

5. The method of claim 1, the method further comprising:
sending HARQ information from the base stations in the active set of soft handover to the user terminal; and
sending the information on which base stations are included in the subset to the user terminal.

6. The method of claim 1, the method further comprising:
sending the information on which base stations are included in the subset to the base stations in the active set; and
ending sending the HARQ information to the user terminal from base stations excluded from the subset.

7. The method of claim 1, the method further comprising:
updating the subset when new base stations to be included in the subset are detected in the active set of soft handover.

8. The method of claim 1, wherein the step of defining the subset is further based on measurements of at least one of signal to noise ratios and other threshold values of the base stations in the active set.

9. The method of claim 8, the method further comprising:
defining a given base station to be excluded from the subset when a signal to noise ratio of the given base station is lower than a signal to noise ratio of a strongest base station in the active set by a predetermined amount.

10. The method of claim 1, the method further comprising:
generating at least one additional subset update command for indicating to the user terminal which base stations in the active set are included in the subset.

11. The method of claim 1, the method further comprising:
adding at least one additional bit to a current soft hand over active setup command and to a soft handover active set update command for indicating that a given base station should be included in the subset.

12. The method of claim 10, the method further comprising:
sending a subset update command after at least one of an active set setup command and an active set update command.

13. A packet radio system using a Hybrid Automatic Repeat reQuest (HARQ), the packet radio system comprising:
a controller configured to control radio resources of a packet radio system, the controller including a transceiver for communicating with a user terminal and at least one base station of the packet radio system, and a first processing unit for controlling functions of the controller;
a user terminal including a transceiver for communicating with the controller and the at least one base station of the packet radio system and a second processing unit for controlling functions of the user terminal; and
more than one base stations communicating with the controller and the user terminal of the packet radio system,
wherein the first processing unit is further configured to define a subset of an active set of soft handover based on performances of base stations in the active set, and to provide information on which base stations are included in the subset, and wherein the second processing unit is further configured to monitor HARQ information received only from base stations that are included in the subset.

14. The packet radio system of claim 13, wherein the first processing unit is further configured to define the subset based on at least one of uplink and downlink measurement reports.

15. The packet radio system of claim 13, wherein the base stations in the active set of soft handover are configured to send the HARQ information to the user terminal and wherein the first processing unit is further configured to send the information on which base stations are included in the subset to the user terminal.

16. The packet radio system of claim 13, wherein the first processing unit is further configured to send the information on which base stations are included in the subset to the base stations communicating with the controller and the user terminal, and wherein base stations excluded from the subset are configured to end sending the HARQ information to the user terminal.

17. The packet radio system of claim 13, wherein the first processing unit is further configured to update the subset when new base stations to be included in the subset are detected in the active set of soft handover.

18. The packet radio system of claim 13, wherein the first processing unit is further configured to define the subset based on measurements of at least one of signal to noise ratios and other threshold values of the base stations in the active set.

19. The packet radio system of claim 18, wherein the first processing unit is further configured to define a given base station to be excluded from the subset when a signal to noise ratio of the given base station is lower than a signal to noise ratio of a strongest base station in the active set by a predetermined amount.

20. The packet radio system of claim 13, wherein the first processing unit is further configured to generate at least one additional subset update command for indicating to the user terminal which base stations in the active set are included in the subset.

21. The packet radio system of claim 13, wherein the first processing unit is further configured to add at least one additional bit to a current soft handover active setup command and to a soft handover active set update command for indicating that a given base station should be included in the subset.

22. A controller for a packet radio system using a Hybrid Automatic Repeat reQuest (HARQ), the controller comprising:
a transceiver for communicating with at least one base station and user terminal of a packet radio system; and
a processing unit for controlling functions of a controller,
wherein the processing unit of the controller is further configured to define a subset of an active set of soft handover based on performances of base stations in the active set, and to provide information on which base stations are included in the subset for enabling a user terminal to monitor HARQ information received only from base stations that are included in the subset.

23. The controller of claim 22, wherein the processing unit is further configured to define the subset based on at least one of uplink and downlink measurement reports.

24. The controller of claim 22, wherein the processing unit is further configured to send the information on which base stations are included in the subset to the user terminal.

25. The controller of claim 22, wherein the processing unit is further configured to send the information on which base stations are included in the subset to base stations of the packet radio system.

26. The controller of claim 22, wherein the processing unit is further configured to update the subset when new base stations to be included in the subset are detected in the active set of soft handover.

27. The controller of claim 22, wherein the processing unit is further configured to define the subset based on at least one of measurements of signal to noise ratios and other threshold values of the base stations in the active set.

28. The controller of claim 27, wherein the processing unit is further configured to define a given base station to be excluded from the subset when a signal to noise ratio of the given base station is lower than a signal to noise ratio of a strongest base station in the active set by a predetermined amount.

29. A user terminal for a packet radio system using a Hybrid Automatic Repeat reQuest (HARQ), the user terminal comprising:
a transceiver for communicating with a controller and at least one base station of a packet radio system; and
a processing unit for controlling functions of a user terminal,
wherein the processing unit is further configured to monitor HARQ information received only from base stations that are included in a subset defined by the controller based on performances of base stations in an active set of soft handover.

30. The user terminal of claim 29, wherein the user terminal is further configured to receive information from the controller about which base stations from the active set of soft handover are included in the subset defined by the controller.

31. The user terminal of claim 30, wherein the user terminal is further configured to receive at least one additional subset update command for indicating which base stations in the active set are included in the subset when receiving information from the controller.

32. A packet radio system using a Hybrid Automatic Repeat reQuest (HARQ), the packet radio system comprising:
a controller for controlling at least one base station of a packet radio system, the controller including first communication means for communicating with a user terminal and the at least one base station of the packet radio system;
a user terminal including second communication means for communicating with the controller and base stations of the packet radio system; and
more than one base stations including third communication means for communicating with the controller and the user terminal of the packet radio system,
wherein the controller further comprises defining means for defining a subset of an active set of soft handover based on performances of base stations in the active set, and indication means for providing information on which base stations are included in the subset, and wherein the user terminal further comprises monitoring means for monitoring HARQ information received only from the base stations that are included in the subset.

33. A controller for a packet radio system using a Hybrid Automatic Repeat reQuest (HARQ), the controller comprising:
communication means for communicating with at least one base station and user terminals of a packet radio system; and
controlling means for controlling functions of a controller,
wherein the controlling means further comprise defining means for defining a subset of an active set of soft hand over based on performances of base stations in the active set, and indicating means for providing information on which base stations are included in the subset for enabling the user terminals to monitor HARQ information received only from the base stations that are included in the subset.

34. A user terminal for a packet radio system using a Hybrid Automatic Repeat reQuest (HARQ), the user terminal comprising:
communication means for communicating with a controller and more than one base stations of a packet radio system; and
controlling means for controlling functions of a user terminal,
wherein the controlling means is further configured to monitor HARQ information received only from base stations that are included in a subset defined by the controller based on performances of base stations in an active set of soft handover.
